(19) United States
(12) Patent Application Publication
(10) Pub. No.: US 2015/0295323 A1
(43) Pub. Date: Oct. 15, 2015

(54) CIRCULAR LOOP CROSSED ELEMENTS OMNIDIRECTIONAL ANTENNA

(71) Applicant: Javier Alberto Garcia, Reading, PA (US)

(72) Inventor: Javier Alberto Garcia, Reading, PA (US)

(21) Appl. No.: 14/658,166

(22) Filed: Mar. 14, 2015

Related U.S. Application Data
(60) Provisional application No. 61/995,550, filed on Apr. 14, 2014.

(51) Int. Cl. H01Q 11/04; H01Q 1/12

(52) U.S. Cl. CPC H01Q 11/04; H01Q 1/1242

(57) ABSTRACT

The main objective of the invention is to provide a broadband omnidirectional antenna that could, for example, be used for the reception of over-the-air television signals on both, the VHF and UHF bands, comprising two circular folded elements, each formed as a self-supporting open-ended loop, arranged with an element inside and slightly below the other in the vertical plane and perpendicularly aligned against each other at 90° angle, in such way that they cross at exactly half way their circumference without making contact, both loops are isolated from ground and from each other using dielectric materials. Said antenna will effectively accept horizontally polarized signals coming from all quadrants of the geographic coordinates in a given location without the need to orient it as long as the signals is received through a quadrant of the antenna, said antenna will resonate over a wide band with an effective gain that overcomes circuit loses for a typical installation and within a wide range of terrain conditions and environments.

### BACKGROUND OF THE INVENTION

The present invention falls within class 343: Communication: Radio wave antennas, subclass 700R/731/732, antenna/traveling wave type/circular loop of the U.S. patent classification definitions for the transmission of radio wave energy through the air for point-to-point communication or for the reception of such transmitted radio wave energy.

An antenna to coupling electrical energy between free space and restricted space; the radiation or collection of such energy together with its transmission to or from a transmitter or receiver is coupled to free space continuously along its length to transmit signal energy between the antenna and free space along its length; said antenna being inherently adapted to, or being arranged to, or including structure to give said antenna a delay or acceleration characteristic in the direction of propagation of the radio wave in space to which said antenna is coupled so that the wave of electric energy conducted along said antenna remains in phase with the associated radio wave moving in space. An antenna wherein each elongated conducting element forms substantially a circle in a single plane.

Due mainly to the TV signal been horizontally polarized, it is particularly challenging to develop an antenna with effective gain that has omnidirectional characteristic, specially one to resonate on such a wide band of frequencies found on both bands of the TV spectrum.

Conventional dipole antennas including all variations of Yagi-Uda and log-periodic antennas used for the reception of FM radio and television in the VHF and UHF frequency bands have directional characteristics with a narrow acceptance angle, such that to achieve optimum reception they must be aligned relatively with the position of the transmitter, keeping those signal sources located at both sides and back of the antenna out, requiring to rotate the antenna to aim it in the direction of the transmitter in order to receive said signals.

Additionally, these prior arts must have multiple components or elements cut to different length in order to resonate and achieve an effective gain on the frequency or band of frequencies they are intended for, making them large, bulky, heavy and difficult to install.

It is an objective of the present invention to improve and tackle upon the challenges and limitations of those prior arts.

### BRIEF SUMMARY OF THE INVENTION

The present invention relates to a broadband antenna with omnidirectional characteristic that has two radiating conductors consisting of two identical open ended circular loops arranged one inside and slightly below the other in the vertical plane, perpendicularly aligned against each other and crossing at exactly half way their circumference without making contact, such antenna will effectively accept signals coming from all quadrants of the geographic coordinates in a given location without the need to rotate it and resonates over a wide band with an effective gain that overcomes circuit loses for a typical installation and within a wide range of terrain conditions and environments, from weak to strong signal strength and in the presence of inclement weather conditions.

### BRIEF DESCRIPTION OF THE DRAWINGS

The description of the present invention makes reference to the annexed drawings wherein:

FIG. 1 is a perspective side view illustrating the basic embodiment of the invention.

FIG. 2 is a perspective side view illustrating the basic embodiment of the invention and one of four possible feed point terminals.

FIG. 3 is a perspective side view illustrating the invention completely assembled with all proposed support structure parts.

FIG. 4 is a top plan view of the present invention illustrated on FIG. 3.

FIG. 5 shows horizontal polar far-field patterns to illustrate the gain response in dBi of the antenna described herein for TV channel 4 or 71 MHz using average ground parameters and the antenna raised 30 feet.

FIG. 6 shows horizontal polar far-field patterns to illustrate the gain response in dBi of the antenna described herein for FM radio 98 MHz using average ground parameters and the antenna raised 30 feet.

FIG. 7 shows horizontal polar far-field patterns to illustrate the gain response in dBi of the antenna described herein for TV channel 10 or 195 MHz using average ground parameters and the antenna raised 30 feet.

FIG. 8 shows horizontal polar far-field patterns to illustrate the gain response in dBi of the antenna described herein for TV channel 17 or 491 MHz using average ground parameters and the antenna raised 30 feet.

FIG. 9 shows horizontal polar far-field patterns to illustrate the gain response in dBi of the antenna described herein for TV channel 27 or 551 MHz using average ground parameters and the antenna raised 30 feet.

FIG. 10 shows horizontal polar far-field patterns to illustrate the gain response in dBi of the antenna described herein for TV channel 35 or 599 MHz using average ground parameters and the antenna raised 30 feet.

FIG. 11 shows horizontal polar far-field patterns to illustrate the gain response in dBi of the antenna described herein for TV channel 43 or 647 MHz using average ground parameters and the antenna raised 30 feet.

FIG. 12 shows horizontal polar far-field patterns to illustrate the gain response in dBi of the antenna described herein for TV channel 50 or 689 MHz using average ground parameters and the antenna raised 30 feet.

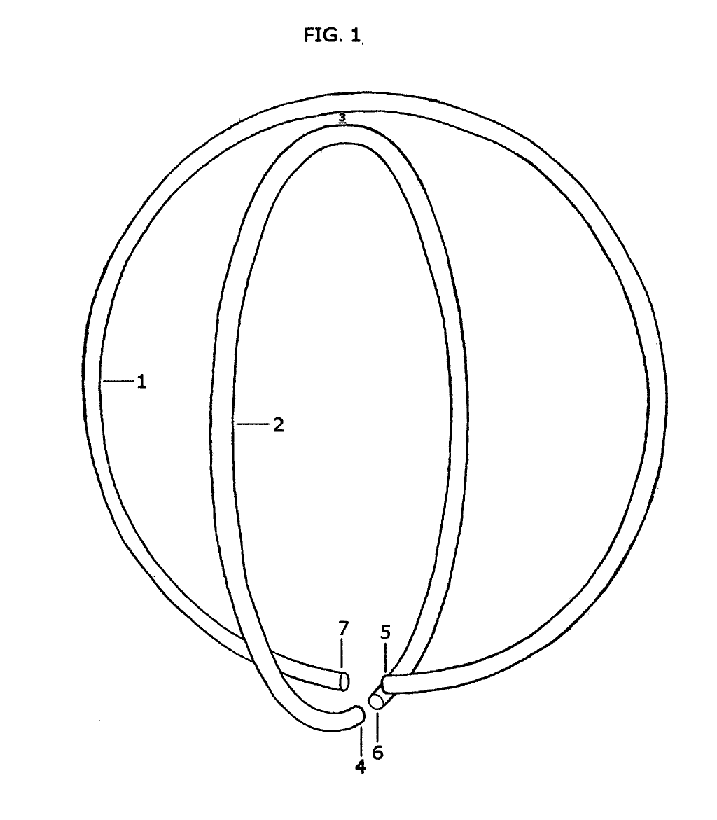

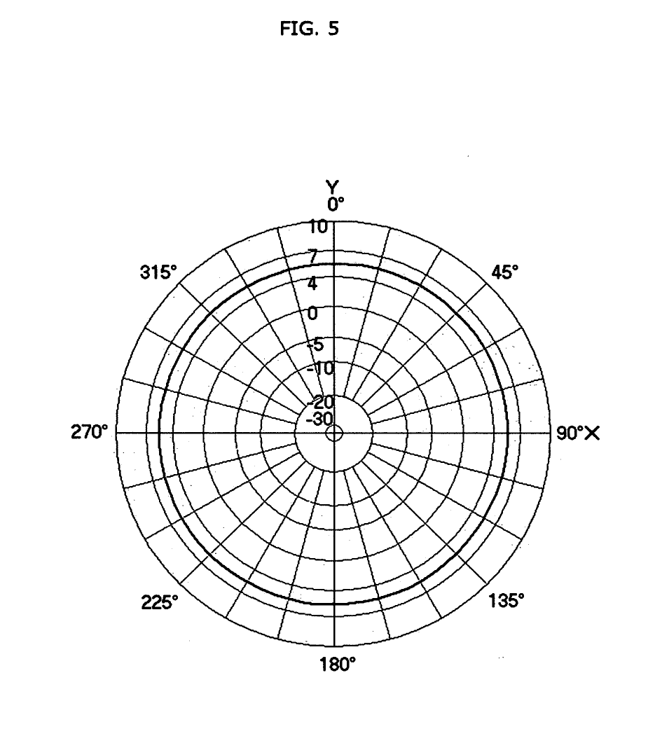

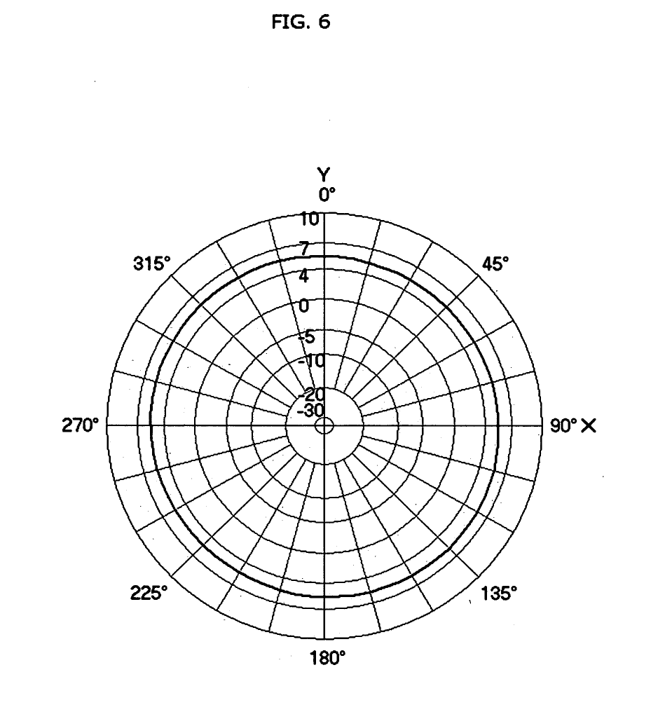

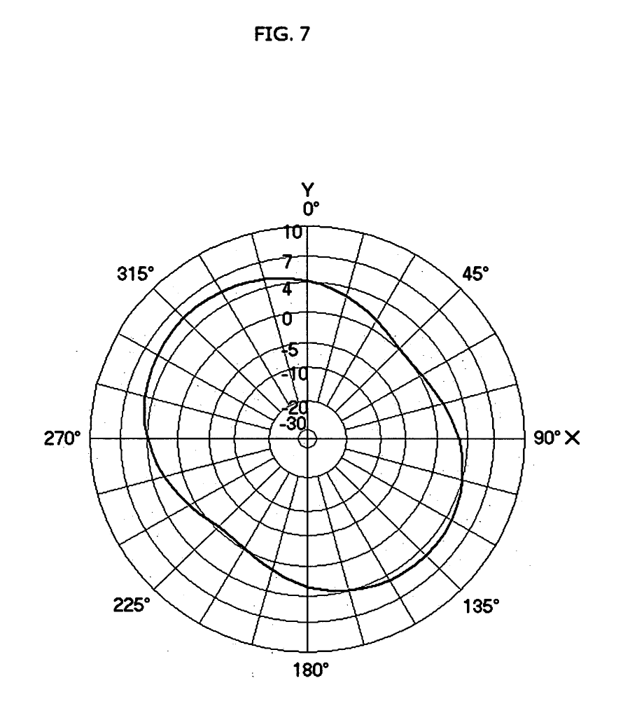

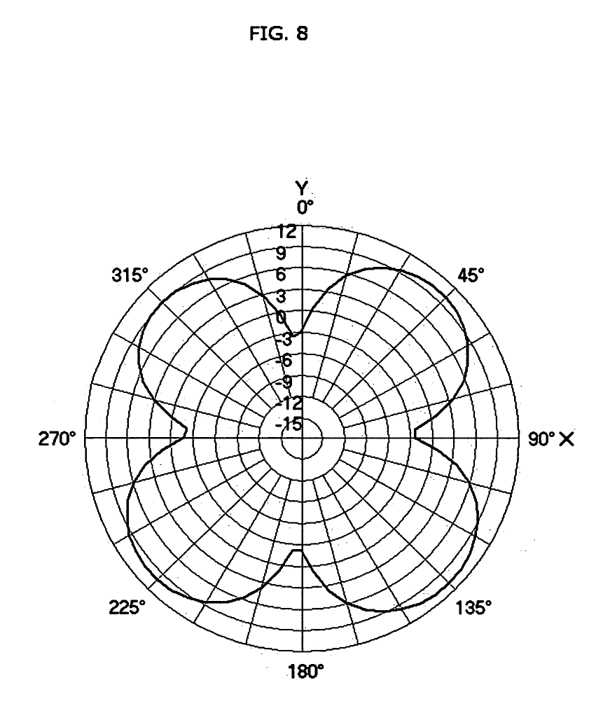

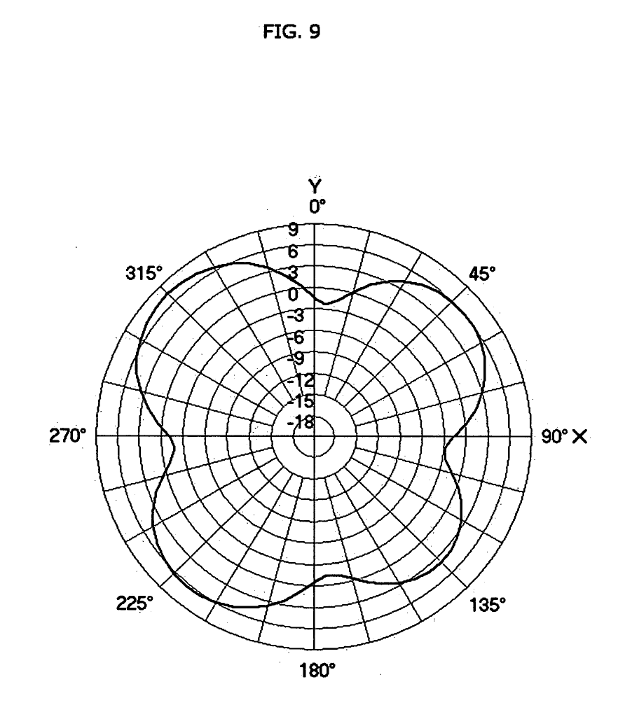

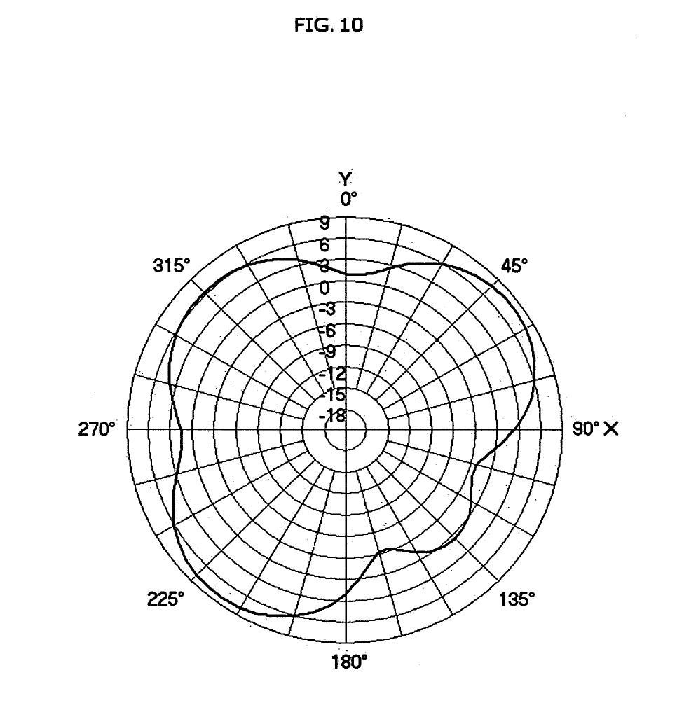

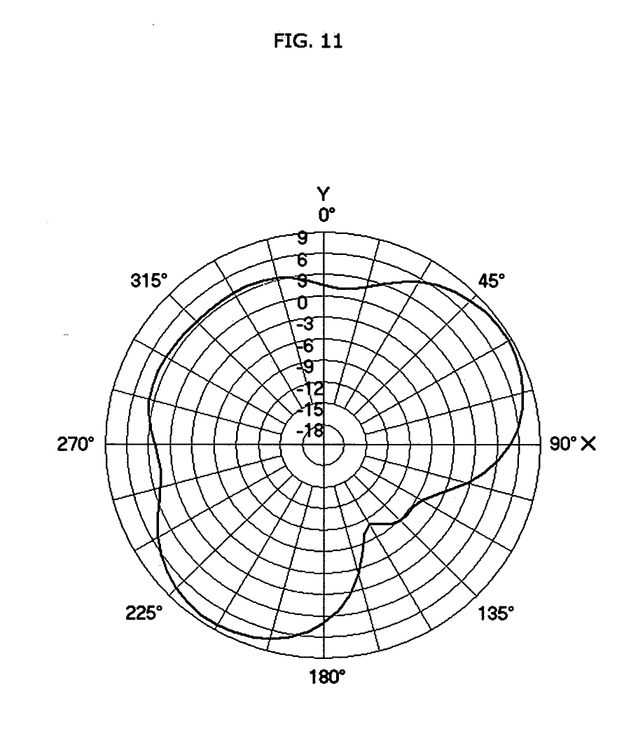

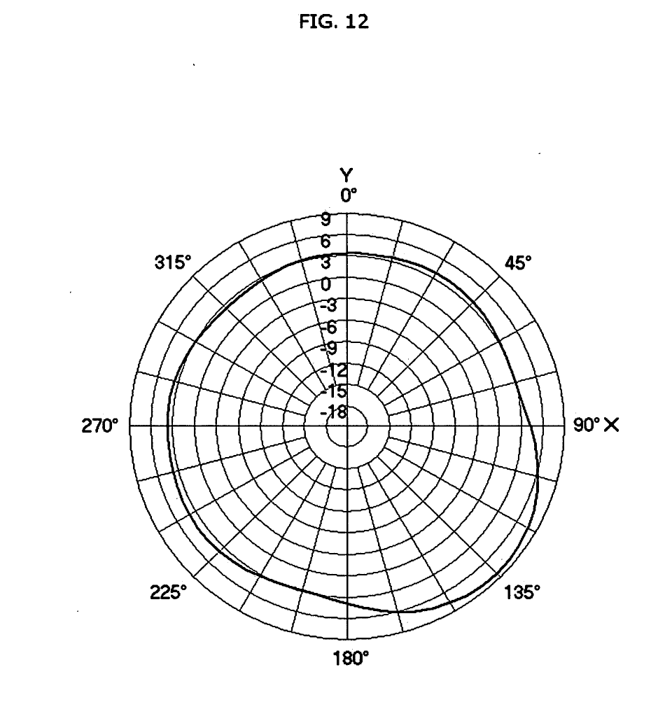

Numbers shown on FIGS. 1-4 are reference characters which are mentioned throughout the present Specification, whereas numbers shown on FIGS. 5-12 are variables, not reference characters, which are not mentioned throughout the present Specification. Additionally the concentric circles on FIGS. 5-12 indicate gain in dBi, and radial lines indicate azimuth in degrees.

### DETAILED DESCRIPTION OF THE INVENTION

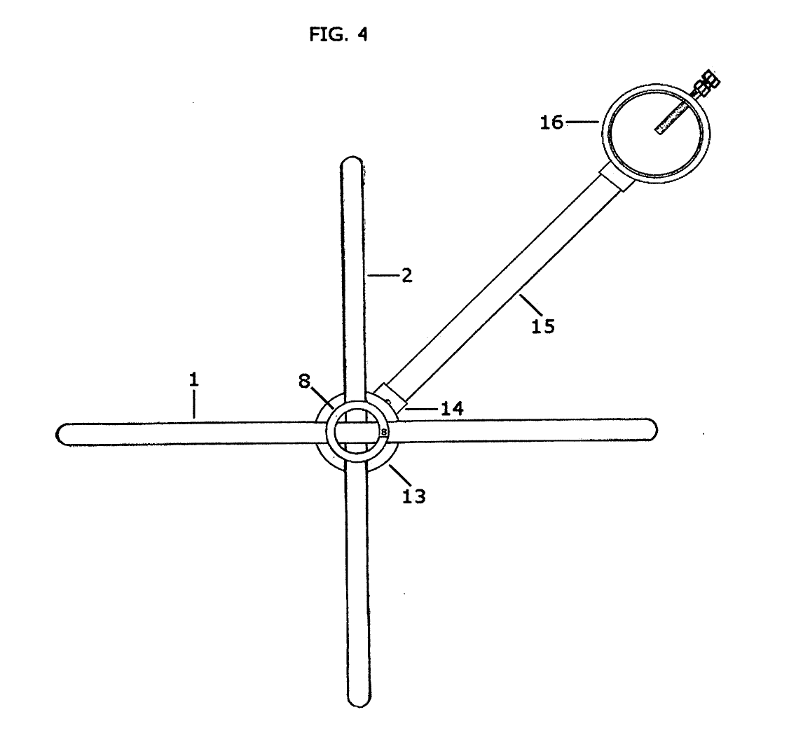

An antenna consisting of two identical open ended circular folded crossed element (1) and element (2), made of metal wires, rods or aluminum tubes (FIG. 1). These two conductive elements (1, 2) are placed one inside and slightly below the other in the vertical plane and perpendicularly aligned against each other at 90° degree angle in such way that they cross at exactly half way their circumference or apex (3) without making contact, resembling a cross when the antenna is viewed directly from the top (FIG. 4).

Both loops are isolated from ground, and against each other by weather resistance, dielectric material members made of plastic or PVC placed at the top apex (3) and at the open ends (4, 5, 6, 7) directly below. To provide support, electrical isolation and to keep the correct distance or gap at the apex (3), a piece of separator (8) is used having two holes drilled perpendicularly one in top of the other. The length of the gap between the loops at this isolated apex intersection (3), and the size of these two holes are equal to the cross-section outside diameter of the wire, rod or tube used to fold the loops (1, 2).

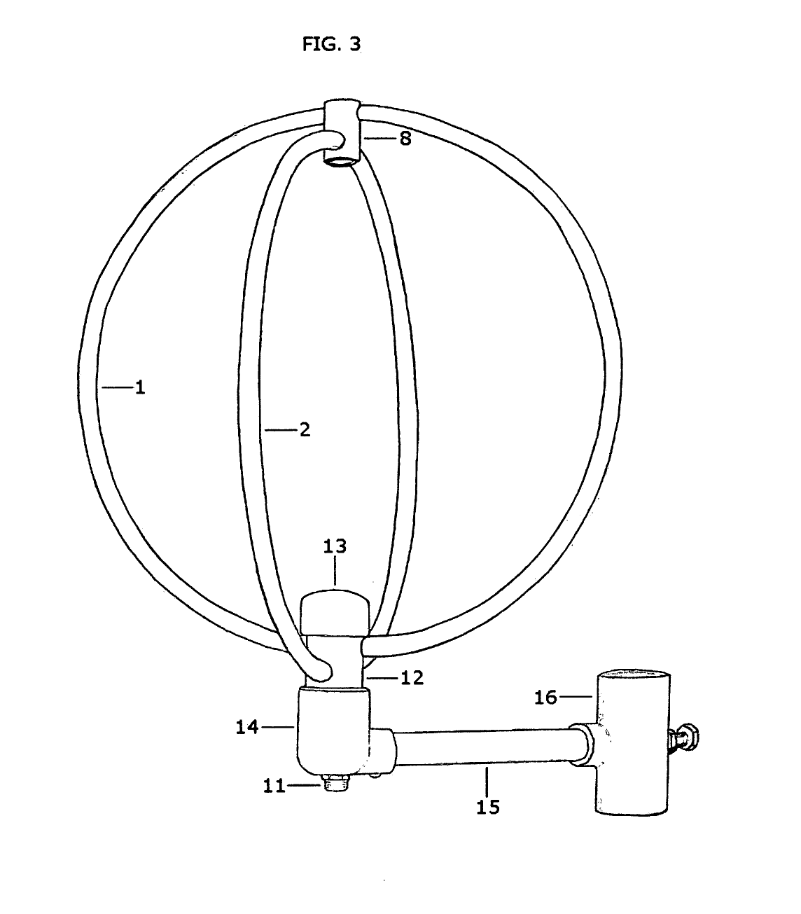

The open end (4), end (5), end (6) and end (7) of both loops (1, 2) are located directly below the top apex isolated intersection (3) on the horizontal plane, also perpendicularly oriented and isolated from each other by a second isolator (12) with such form that allows all four ends of both loops (4, 5, 6, 7) to be seated at their corresponding height, and without distorting the circular shape of the loops (1, 2) at this lower point of the antenna (FIG. 3). The gap between end (5) and end (7) of loop (1) has the same length than the gap between end (4) and end (6) of loop (2) and equal to the gap at the apex (3).

The feed point, where the signal from the antenna is taken or applied to, is where one lead of a balanced 300 ohms feed line (9) is connected to the end (7) of the first loop (1) and the other lead of this feed line (9) is connected to the end (4) of the second loop (2), after drilling the corresponding holes near the edge in order to fasten the connection terminals using bolts (17) & nuts (18) so a 4:1 impedance matching transformer or balun (10) can be installed and removed easily. It is noteworthy to mention that ends (4, 5) or ends (5, 6) or ends (6, 7) can also be designated as the feed point.

The feed line (9) includes two electrical conductors that have a predetermined length that are aligned substantially in parallel, and spaced apart a predetermined distance by plural insulators to achieve a 300 ohms impedance. The circuitry of the 4:1 balun (10) enables efficient impedance coupling of the balanced output RF signals from the antenna to an unbalanced RF coaxial cable having 75 ohms impedance.

When end (4) and end (7) are chosen as the feed point, the set of free floating end (5) of element (1) and end (6) of element (2) are isolated from each other and from the feed point (4, 7), therefore ends (5, 6) must be anchored and tighten securely to said bottom isolator piece (12).

An unbalanced feed line like a 75 ohms RF coaxial cable can be connected to the secondary unbalanced output (11) of a 4:1 impedance matching transformer (10) to allow the antenna to be connected to a modem receiver/transmitter apparatus like a television or radio equipped with an unbalanced input/output F connector.

The antenna comprising two circular folded crossed element (1) and element (2), separator (8), isolator hub (12), matching transformer (10), bolts & nuts (17, 18) should be erected on a non-conductive support structure made of plastic or PVC material which includes a cap (13), 90° degree elbow (14), arm (15) and a mast mount bracket (16) in order to be erected vertically and securely on a pole or tower.

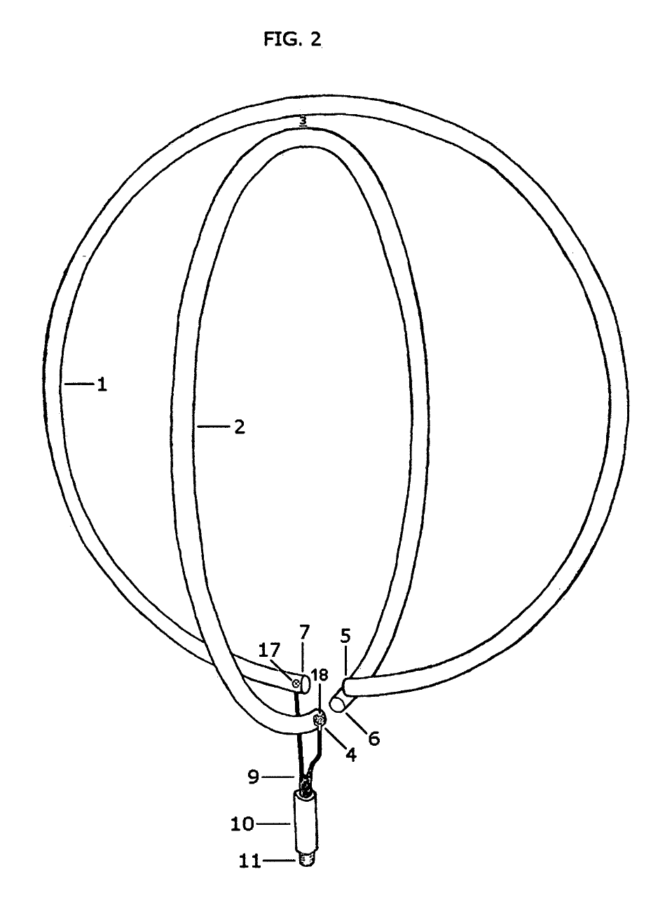

The embodiment shown on FIG. 2 for television reception covering the entire VHF (low/high) and UHF bands, should have element (1) and element (2) crafted with two 9.5 mm cross-section O.D. aluminum tubes, folded into a 33 to 35 cm diameter circular loop each. The gap at the apex (3) and the separation between each loop ends should be the same than said tubes cross-section. Each hole for the feed point (4, 7) should accept a #10-24×14 mm to 16 mm screw (17) and corresponding nut (18) drilled at 4.0 mm from the edge of each loop ends in order to connect the matching transformer (10) to the antenna elements (1, 2).

The support structure of the invention shown on FIG. 3 which includes the separator (8), isolator hub (12) and the additional support structure parts (13, 14, 15, 16) can be assembled of PVC tubing and fittings or be molded from plastic. For example, a 0.5 inch trade measure pipe can be used for the separator (8) and the arm (15), a 1.0 inch trade measure for the cap member (13), a 1.0 inch trade measure piece of low pressure pipe for the isolator hub member (12), a 1.0×0.5 inch trade measure for the 90 degree elbow member (14) and a 1.0×0.5×1.0 inch trade measure tee for the mast mount bracket member (16).

The antenna configuration shown on FIG. 3, made of aluminum tubing and PVC plastic parts, with the dimension and measurements revealed above is intended for over-the-air television and frequency modulated (FM) radio signal reception.

While the present invention is described herein with reference to illustrative embodiments for particular applications, it should be understood that the invention is not limited thereto.

Those having ordinary skill in the art and access to the information provided herein will recognize additional modifications, applications and embodiments within the scope hereof and additional fields in which the present invention would be of significant utility.

It is to be noted that the dimensional relationships for the parts of the above invention, including variations in size, assembly, materials, shape, form, function, operation and use are apparent and obvious to anyone skilled in the art, and all equivalent relationships to those illustrated in the drawings and described in the specifications are encompassed by the present invention.

Therefore, the foregoing is considered as illustrative of the principles of the invention only since numerous modifications and changes might occur to those skilled in the art, it is not intended to limit the present invention to the exact configuration and operation shown and described, and accordingly, all suitable equivalent modifications may be fallen within the scope of this invention.

What is claimed is:

1. An antenna consisting of two identical open ended circular folded elements arranged with an element inside and slightly below the other in the vertical plane and perpendicularly aligned against each other at 90° degree angle in such way that they cross at exactly half way their circumference or apex without making contact, resembling a cross when the antenna is viewed directly from the top, said apex is the highest point and the open ends are located at the lowest point of the antenna, said elements having rounded cross-section.

2. An antenna as claimed in claim 1 that has a impedance matching transformer or balun having a balanced RF input and an unbalanced RF output, and having an impedance ratio of 4:1, which provides a nominal impedance transformation from 300 ohms to 75 ohms.

3. An antenna as claimed in claim 1-2 that has a dielectric member at the top apex which also provides the correct gap between the elements of the antenna at its highest point.

4. An antenna as claimed in claim 1-3 that has a dielectric hollow hub member, directly below the member described in claim 3, placed at the center of its vertical axis, in the vertical plane, which accepts all four ends of the two elements seated at the same relative height than the gap at the apex with such internal dimension that allows the connection to the antenna elements and the placement of a shielded impedance matching circuitry or balun enclosed and protected from the weather.

5. An antenna as claimed in claim 1-4 that has a dielectric cap member that fit on top of the member described in claim 4 that covers its top to keep water and other contaminants from affecting the connections.

6. An antenna as claimed in claim 1-5 that has a dielectric base with a form of a 90° elbow so that its vertical section is twice as wide than the horizontal section, said vertical section can be fitted to the bottom of the member described in claim 4, and a female coaxial cable terminal connector can be embed on its horizontal section.

7. An antenna as claimed in claim 1-6 that has a dielectric arm member which its first end can be fitted to the horizontal section of member claimed in claim 6 and its second end can be fitted to a mast mount bracket member.

8. An antenna as claimed in claim 1-7 that has a mast mount bracket member that can be fitted to the second end of the arm member claimed in claim 7 to facilitate the antenna to be erected vertically and securely.

9. An antenna as claimed in claim 1-8 has 360° omnidirectional characteristic in the VHF bands and multi-directional characteristic on the UHF band.

10. An antenna as claimed in claim 1-9 will resonate on the VHF and UHF bands without the need to have a secondary larger dedicated element for VHF reception, with an effective gain over both bands that overcomes circuit loses for a typical installation and within a wide range of terrain conditions including from weak to strong signal strength environments.

11. An antenna as claimed in claim 1-10 is easy to install, relatively smaller in size, lighter in weight and attractive in appearance when compared to those omnidirectional TV antennas that try to achieve reception on the entire TV bands of frequencies, due to this, the described invention is also suitable for indoors use.

12. The antenna as claimed in claims 1-11 has a very strong wind and weather resistance, making it very durable and resilient under inclement climate conditions.

13. The present non-provisional utility patent application claims the benefit of an earlier filed provisional patent application No. 61/995,550 dated Apr. 14, 2014 and titled Double Loop Crossed Elements Omnidirectional Antenna.
